(19) United States
(12) Patent Application Publication
(10) Pub. No.: US 2018/0197255 A1
(43) Pub. Date: Jul. 12, 2018

(54) WEB BASED PLATFORM AND SYSTEM FOR TRACKING IRRIGATION INFORMATION IN A RESIDENTIAL ZONE

(71) Applicant: Michael Glenn Sloan, Phoenix, AZ (US)

(72) Inventor: Michael Glenn Sloan, Phoenix, AZ (US)

(21) Appl. No.: 15/866,792

(22) Filed: Jan. 10, 2018

Related U.S. Application Data
(60) Provisional application No. 62/445,176, filed on Jan. 11, 2017.

(51) Int. Cl. G06Q 50/06; H04M 1/725; H04W 4/38; A01G 25/16

(52) U.S. Cl. CPC G06Q 50/06; H04M 1/72544; G05B 2219/2625; A01G 25/16; H04W 4/38

(57) ABSTRACT

A web based platform, system and user interface for tracking and displaying residential irrigation usage uses real-time tracking of water usage to generate a map of irrigation usage for an area. The system records irrigation usage for, for example, a residential area and provides on-demand information of irrigation usage both current and past to an end user. The user interface shows irrigation usage status of subscribing residences. A residence may be selected from the map and their current and historical water usage is displayed. In some embodiments, overwatering or underwatering of a residence may be indicated on the map so that the user may select the residence based on a quick glance of the map and symbol representing the residences.

### CROSS-REFERENCE TO RELATED APPLICATIONS

This application claims benefit under 35 U.S.C. § 119(e) of U.S. Provisional Application having Ser. No. 62/445,176 filed Jan. 11, 2017, which is hereby incorporated by reference herein in its entirety.

### BACKGROUND

The embodiments herein relate generally to irrigation systems, and more particularly to a web based platform and system for tracking irrigation information in a residential zone.

Current irrigation monitoring for residences is performed manually. Some residential areas require a water service to deliver water for irrigation. However, since most of the irrigation administration is manually controlled, tracking usage can be difficult and prone to error. As such, it is difficult to monitor and track water usage historically and to provide useful information related to usage. As a result, it is common for irrigation to be performed inefficiently.

As can be seen, there is a need for an improved system and method of tracking irrigation usage.

### SUMMARY

In one aspect of the subject disclosure, a computer program product for a system tracking and displaying residential irrigation usage on computer devices comprises a non-transitory computer readable storage medium having computer readable program code embodied therewith. The computer readable program code is configured to: receive from a meter connected to a water line of a residence, at a backend server of the system, irrigation usage activity for a residence; record the irrigation usage into a database and a file associated with the residence and the residence's irrigation usage; receive a request from an end user through a network, for irrigation information associated with the residence; retrieve the irrigation information associated with the residence from the database; and provide a display of the irrigation information through a web based platform to the requesting end user on a computing device electronic display, wherein the irrigation information provides historical usage including start and stop times of irrigation, duration of irrigation, and a real-time usage map of irrigation activity for a residential area.

In another aspect, a computer program product for a user interface tracking and displaying residential irrigation usage comprises a non-transitory computer readable storage medium having computer readable program code embodied therewith. The computer readable program code is configured to: generate the user interface on a mobile computing device, wherein the user interface is connected to a system tracking irrigation usage for a plurality of residences;

generate a map on the user interface showing a plurality of residences in an area subscribed to the system; receive from a meter connected to a water line of the plurality of residences, at a backend server of the system, real-time irrigation usage activity for each subscribed residence; and display the irrigation information for each of the subscribed residences in the area on the generated map in response to selection of each respective residence shown in the user interface by an end user.

### BRIEF DESCRIPTION OF THE FIGURES

The detailed description of some embodiments of the invention is made below with reference to the accompanying figures, wherein like numerals represent corresponding parts of the figures.

FIG. 1 is a block diagram of a computer system/server according to an embodiment of the subject technology.

FIG. 2 is a block diagram of a network system for generating a user interface displaying irrigation usage for residences according to an embodiment of the subject technology.

FIG. 3 is a mobile computing device displaying a screenshot of a mobile app user interface for a selected residence with irrigation usage tracked according to an embodiment of the subject technology.

FIG. 4 is a mobile computing device displaying a screenshot of a mobile app user interface showing user settings according to an embodiment of the subject technology.

FIG. 5 is a mobile computing device displaying a screenshot of a mobile app user interface showing a map of residences and a real-time map of irrigation use in a residential area according to an embodiment.

FIG. 6 is a mobile computing device displaying a screenshot of a mobile app user interface showing an enlarged view taken along the line 6-6 of FIG. 5.

FIG. 7 is a mobile computing device displaying a screenshot of a mobile app user interface showing irrigation information for a selected subscribed residence according to an embodiment.

### DETAILED DESCRIPTION OF CERTAIN EMBODIMENTS

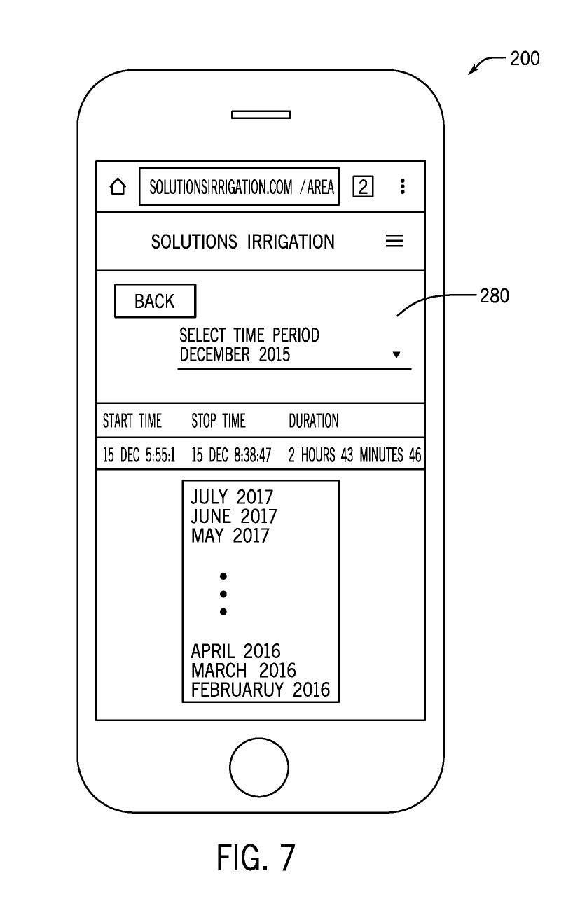

Referring now to the Figures, in general, embodiments of the disclosed invention provide a system and process that generates a user interface which displays on-demand, irrigation usage for residences. Aspects of the disclosed embodiments solve the particular problems associated with the industry of irrigation services. For example, it will be appreciated that embodiments generate real-time maps of residences along with real-time reports of their water usage via a mobile app interface to the user. The system tracks an irrigation run for each residence. Information for the irrigation run (accessible via a mobile device user interface) may include for example as shown in FIG. 7, start and stop times of irrigation and the total irrigation duration. In addition, counter history for each residence on the service may be recorded and used to determine when a residence may be overwatering or underwatering based on the amount of water purchased or based on the system determining that the current amount of water used deviates from a historical average usage.

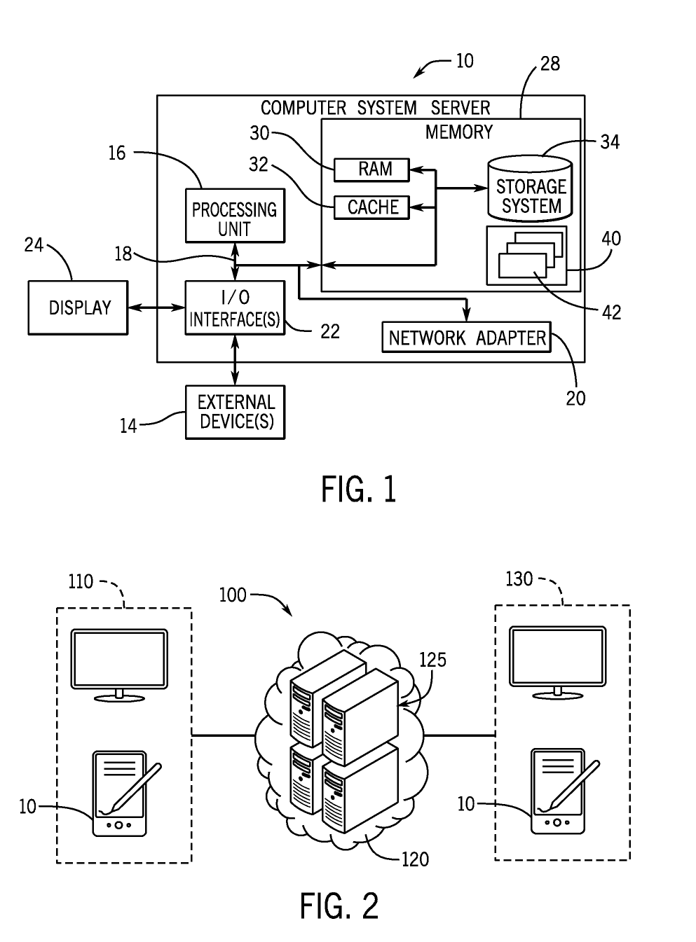

Referring now to FIG. 1, a schematic of an example of a computer system/server 10 is shown. The computer system/server 10 is shown in the form of a general-purpose computing device. However, by application of some of the elements and process disclosed below, some embodiments may establish the computer system/server 10 as a special purpose computer for purposes of providing the user interface, irrigation platform, and tracking of irrigation usage as disclosed herein. The components of the computer system/server 10 may generally include, but are not limited to, one or more processors or processing units 16, a system memory 28, and a bus 18 that couples various system components including the system memory 28 to the processor 16.

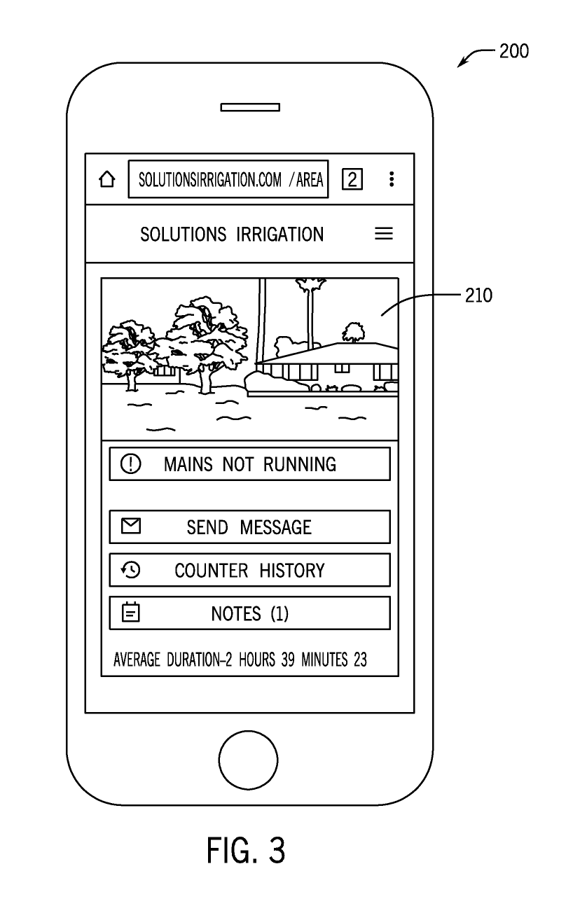

The computer system/server 10 may perform functions as different machine types depending on the role in the system the function is related to. For example, depending on the function being implemented at any given time when interfacing with the system, the computer system/server 10 may be an end user device such as, mobile telephone devices (for example, as shown in FIGS. 3-7), handheld or laptop devices, personal computer systems, tablet devices, set top boxes, programmable consumer electronics, or wearable computing devices (for example smart watches, smart glasses, etc.). In some forms, the computer system 10 may be a host server for the system, hosting a web based platform, which is connected to the end user device through a network as described more fully below in FIG. 2, which may include for example server computer systems, multiprocessor systems, microprocessor-based systems, network PCs, and distributed cloud computing environments that include any of the above systems or devices, and the like.

The computer system/server 10 may be described in the general context of computer system executable instructions, such as program modules, being executed by a computer system (described for example, below). In some embodiments, the computer system/server 10 may be a cloud computing node connected to a cloud computing network (not shown). The computer system/server 10 may be practiced in distributed cloud computing environments where tasks are performed by remote processing devices that are linked through a communications network. In a distributed cloud computing environment, program modules may be located in both local and remote computer system storage media including memory storage devices.

The computer system/server 10 may typically include a variety of computer system readable media. Such media could be chosen from any available media that is accessible by the computer system/server 10, including non-transitory, volatile and non-volatile media, removable and non-removable media. The system memory 28 could include one or more computer system readable media in the form of volatile memory, such as a random-access memory (RAM) 30 and/or a cache memory 32. By way of example only, a storage system 34 can be provided for reading from and writing to a non-removable, non-volatile magnetic media device typically called a “hard drive” (not shown). The system memory 28 may include at least one program product 40 having a set (e.g., at least one) of program modules 42 that are configured to carry out the functions of embodiments of the invention. The program product/utility 40, having a set (at least one) of program modules 42, may be stored in the system memory 28 by way of example, and not limitation, as well as an operating system, one or more application programs, other program modules, and program data. Each of the operating system, one or more application programs, other program modules, and program data or some combination thereof, may include an implementation of a networking environment. The program modules 42 generally carry out the functions and/or methodologies of embodiments of the invention as described below, including for example providing tracking of irrigation usage, storing residence associated information and historical irrigation usage, generating user interfaces with real-time mapping and display of irrigation activity, calculating historical usages and averages, and determinations of overwatering, underwatering, and any deviations from historical averages.

The computer system/server 10 may also communicate with one or more external devices 14 such as a keyboard, a pointing device, a display 24, etc.; and/or any devices (e.g., network card, modem, etc.) that enable the computer system/server 10 to communicate with one or more other computing devices. Such communication can occur via Input/Output (I/O) interfaces 22. Alternatively, the computer system/server 10 can communicate with one or more networks such as a local area network (LAN), a general wide area network (WAN), and/or a public network (e.g., the Internet) via a network adapter 20. As depicted, the network adapter 20 may communicate with the other components of the computer system/server 10 via the bus 18.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any combination of one or more computer readable media (for example, storage system 34) may be utilized. In the context of this disclosure, a computer readable storage medium may be any tangible or non-transitory medium that can contain, or store a program (for example, the program product 40) for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

Aspects of the disclosed invention are described below with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor 16 of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

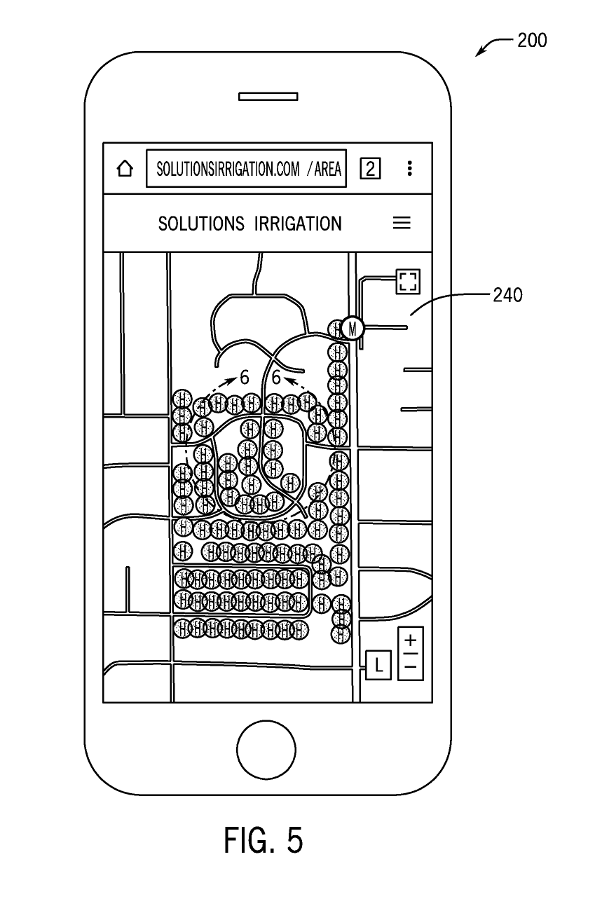

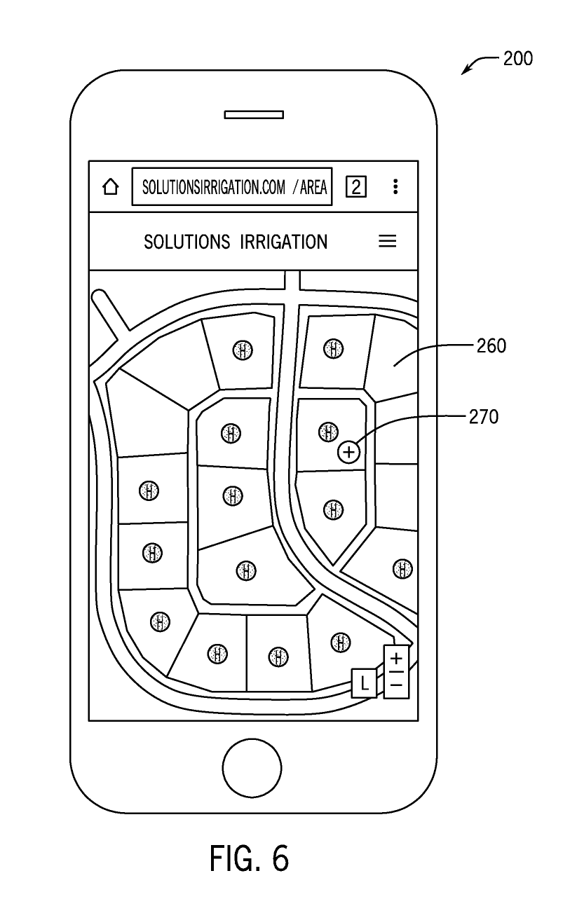

Referring now to FIG. 2, a block diagram of a system 100 for tracking and displaying residential irrigation usage is shown. The system 100 includes a network 120 which may include a backend host server 125 storing a software embodiment of the disclosed invention. The system 100 may connect an end user's (for example, a service provider) computing device 110 to tracking equipment (for example, a meter connected to a water line) for a residence 130 through a network 120. In some embodiments, the meter or other tracking equipment may include a radio transmitter to provide the tracked information to the server 125. For sake of illustration, only one residence 130 is shown but it will be understood that a plurality of residences 130 (as shown in the user interfaces of FIGS. 5 and 6) and their irrigation information may be accessed the network 120 as defined by geographic or other system defined limitations. The end users' computing device 110 may interact with the system 100 via a computer system 10. It will be understood that the electronic device used by the end user and the server 125 may function for example, under the description the computer system/server 10 of FIG. 1. In some embodiments, the network 120 may be a cloud based environment. In some embodiments, the end users of residences 130 may also access the platform based aspects of the system and a mobile app via their own computer systems 10.

Referring now to FIGS. 3-7, a plurality of screenshots of a user interface are shown via a mobile computing device 200 (which may function according to the description of computer system 10 of FIG. 1) are shown according to exemplary embodiments. In general, the system compiles irrigation usage per residence. As may be appreciated, the service provided through the app may be used by residential owners and irrigation service providers alike.

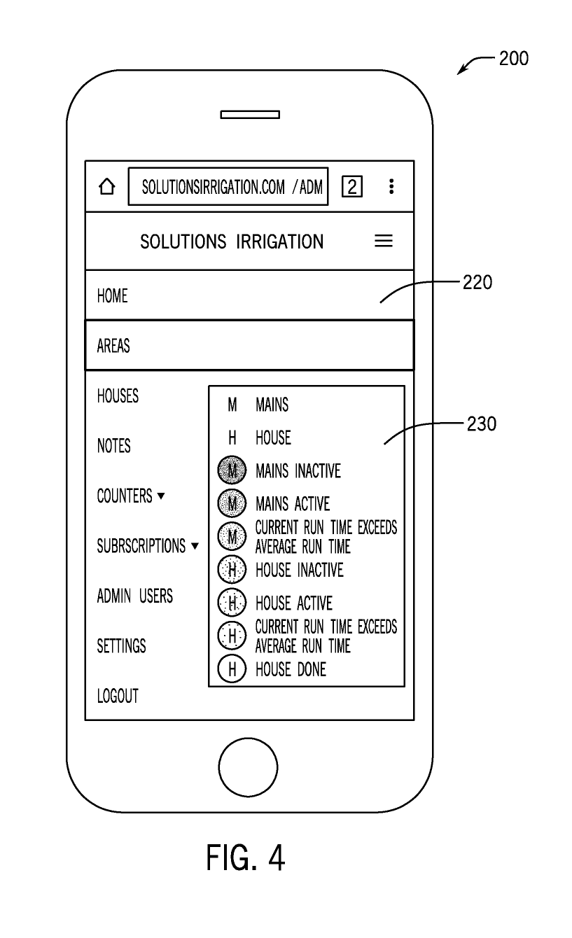

The following will be described from the perspective of a service provider that provides purchased irrigation to residences that are not part of a water utility that pumps water to their location. FIG. 4 shows a user interface that displays user settings and a map legend 230 that describes irrigation information for residences that are mapped (seen in FIGS. 5 and 6). From within this user interface, the user may select a subscribing residence from a drop-down list 220. In some embodiments, the system provides a real-time map 240 (FIG. 5) of irrigation usage among residences that have an active account through the service (sometimes referred to as “subscribing residences”). The map 240 may show whether irrigation for a given residence is active, currently running, or done for the day. FIG. 6 shows an enlarged section of the map 240 for a neighborhood 260 in the irrigation plane. When the user wishes to view the irrigation information for a specific residence 270, the user selects a symbol on the map associated with the residence 270 (for example, an encircled “H” may be used that includes shading representing a status as shown in FIG. 4).

Details for the selected residence may be shown on another user interface 210 (FIG. 3). The details may include historical usage including start and stop times of irrigation and duration of irrigation. In some embodiments, a real-time usage map of irrigation activity for a residential area is shown. FIG. 5, for example, may show at a glance, whether the main water line and/or whether any of the houses exceed their average run time. As will be appreciated, the system may use the historical irrigation information for a home(s) and compare it to a current run-time. If the current run-time exceeds the historical average, the residence's status may provide an indicator which may alert the end user of the potential overwatering. Conversely, the system may determine underwatering by comparing the historical average to the current run-time and may issue an alert identifying the potential underwatering. Historical irrigation information for a residence may be accessed by selecting a time period for the residence (for example, as shown in the calendar selection section 280 of FIG. 7). The mobile app may also include a feature (see FIG. 3) for sending a message to or from, for example, a service provider which may be used for alerting parties to inefficient irrigation.

As will be appreciated, aspects of the system 100 help with irrigating a property more efficiently and conserving water by having more accurate information when ordering water for the properties. A user may access all the irrigation runs for each residence in an area and their history by just clicking on the property shown in the user interface map and navigating through the menu of previous months. For example, if an owner orders 24 hours of water time and only use 22 hours the 2 hours left is classified as wasted. The owner is thus able to identify inadequate or over ordering of water and is able to adjust their water needs for the next month accordingly.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A computer program product for a system tracking and displaying residential irrigation usage on computer devices, the computer program product comprising a non-transitory computer readable storage medium having computer readable program code embodied therewith, the computer readable program code being configured to:
receive from a meter connected to a water line of a residence, at a backend server of the system, irrigation usage activity for a residence;
record the irrigation usage into a database and a file associated with the residence and the residence's irrigation usage;
receive a request from an end user through a network, for irrigation information associated with the residence;
retrieve the irrigation information associated with the residence from the database; and
provide a display of the irrigation information through a web based platform to the requesting end user on a computing device electronic display, wherein the irrigation information provides historical usage including start and stop times of irrigation, duration of irrigation, and a real-time usage map of irrigation activity for a residential area.

2. The computer program product of claim 1, wherein the display of the irrigation information is shown on a mobile device based application.

3. The computer program product of claim 2, further comprising computer readable code configured to generate a map showing a plurality of residences in an area subscribed to the system.

4. The computer program product of claim 3, wherein the residence of claim 1 is a selected residence from among the plurality of residences of claim 3, and further comprising computer readable code configured to display the irrigation information for the selected residence in response to selecting the selected residence from among the plurality of residences shown on the map.

5. The computer program product of claim 4, further comprising computer readable code configured to display overwatering or underwatering of the selected residence based on the displayed irrigation information for the selected residence.

6. A computer program product for a user interface tracking and displaying residential irrigation usage, the computer program product comprising a non-transitory computer readable storage medium having computer readable program code embodied therewith, the computer readable program code being configured to:
generate the user interface on a mobile computing device, wherein the user interface is connected to a system tracking irrigation usage for a plurality of residences;
generate a map on the user interface showing a plurality of residences in an area subscribed to the system;
receive from a meter connected to a water line of the plurality of residences, at a backend server of the system, real-time irrigation usage activity for each subscribed residence; and
display the irrigation information for each of the subscribed residences in the area on the generated map in response to selection of each respective residence shown in the user interface by an end user.

7. The computer program product of claim 6, wherein the irrigation information provides historical usage including start and stop times of irrigation, duration of irrigation, and overwatering or underwatering of the selected residence, wherein the overwatering or underwatering of the selected residence is based on an amount of water ordered by a customer of the residence.

8. The computer program product of claim 6, further comprising computer readable code configured to:
record the irrigation usage of each subscribed residence into a database;
generate historical irrigation usage for each subscribed residence;
determine whether a current irrigation run-time for the selected residence exceeds an average irrigation run-time based on the generated historical irrigation usage; and
display in the user interface, an indicator of more water being used than historically measured in response to the current irrigation run-time for the selected residence exceeding an average irrigation run-time.
